(19) United States
(12) Patent Application Publication
(10) Pub. No.: US 2026/0201948 A1
(43) Pub. Date: Jul. 16, 2026

(54) GEAR SHIFT CONTROL SYSTEM FOR VEHICLE, AND CONTROL METHOD THEREOF

(71) Applicant: Hyundai Kefico Corporation, Gunpo (KR)

(72) Inventors: John Ha Lee, Gunpo (KR); Jong Jin Park, Gunpo (KR); Tae Hyun An, Gunpo (KR); Sung Hyun Park, Gunpo (KR)

(21) Appl. No.: 19/448,760

(22) Filed: Jan. 14, 2026

(30) Foreign Application Priority Data
Jan. 15, 2025 (KR) 10-2025-0006430

(51) Int. Cl. F16H 61/02; F16H 59/58

(52) U.S. Cl. CPC F16H 61/0213; F16H 59/58; F16H 2061/0234

(57) ABSTRACT

A gear shift control system includes a driving information unit configured to detect driving information regarding a driving state of a vehicle, a driving situation determination unit provided with a torque steer monitoring mode for performing torque steer monitoring and configured to detect torque steer based on the driving information of the driving information unit, an up-counter operation unit configured to count the number of occurrences of the torque steer in the torque steer monitoring mode of the driving situation determination unit, a torque-steer and driving-information storage unit configured to store the number of occurrences of the torque steer and a driving situation provided, and a torque-steer prediction and blocking unit provided with a pre-torque steer prevention mode and configured to predict and prevent the torque steer.

### CROSS REFERENCE TO RELATED APPLICATION

The present application claims Korean Patent Application No. 10-2025-0006430, filed January 15, 2025, the entire contents of which are incorporated by reference herein.

### BACKGROUND

### (a) Technical Field

The present disclosure relates to a gear shift control system for a vehicle and a control method thereof, more particularly, to the gear shift control system for preventing torque steer by predicting rapid acceleration situations, and which is configured to eliminate torque imbalance for vehicle wheels in the rapid acceleration situations.

### (b) Description of the Related Art

Recently, new vehicles have widely adopted a Motor Driven Power Steering (MDPS) system as a steering system capable of changing and controlling steering assist power generated by motor output according to driving conditions of a vehicle.

The MDPS system may include sensors such as a steering angle sensor for detecting steering angles depending on a steering wheel operation of a driver, a torque sensor for detecting steering torque applied to the steering wheel by the driver, and a vehicle speed sensor for detecting vehicle speed, and include a controller (i.e., an MDPS ECU) and a steering motor (i.e., an MDPS motor). A wheel speed sensor, an engine RPM sensor, a yaw rate sensor, and the like may also be used as the sensors for the MDPS system.

In addition, a vehicle having an internal combustion engine has different structures on left and right sides of vehicle body due to the structural characteristics and arrangement status of the engine and transmission, so there may be a difference in driving torque transmitted to the left and right vehicle wheels when sudden starts and sudden acceleration occur.

Due to the difference in driving torque transmitted to left and right wheels, a vehicle may exhibit torque steer, causing the vehicle to pull to one side or the steering wheel to turn unintentionally. Torque steer may reduce the safety of the vehicle.

Therefore, torque steer is a phenomenon in which a vehicle pulls to one side due to the tugging of the steering wheel under sudden starts and sudden acceleration. In a front-wheel drive vehicle, there may be a difference in torque transmitted to the left and right wheels due to differences in the left and right lengths and angles of a drivetrain (i.e., drive shafts, etc.), thereby ultimately causing the vehicle to pull to a direction of a longer drive shaft.

In other words, torque steer is a common phenomenon in front-wheel drive vehicles, where the torque steer may cause an accident due to the vehicle pulling to one side under sudden starts, thereby threatening the safety of a driver, or producing fatigue and/or anxiety to the driver due to steering in a direction not desired by the driver.

In order to address such problems of torque steer, an equal-length drive shaft with small differences in the left and right lengths, angles, and rigidity ratios may be used, but there may be a problem of increased cost as well as difficulties in design layout.

In addition, MDPS systems of newer vehicles use MDPS compensation control for reducing torque steer as a way of solving the torque steer problem through control rather than hardware methods. That is, a vehicle equipped with an MDPS system suppresses the torque steer phenomenon through the steering angle of Motor Driven Power Steering (MDPS), the brake compensation of Traction Control System (TCS), or the like when torque steer occurs.

However, such conventional technologies have the limitation of being unable to control a problematic situation not to occur at all, but just correcting this situation when torque steer occurs during driving or just keeping the state of vehicle veering due to the torque steer under control.

### SUMMARY

An objective of the present disclosure is to overcome problems of existing torque steer control technology in order to correct torque steer that may occur during driving.

That is, the objective of the present disclosure is to provide a control strategy of a transmission controller capable of preventing torque steer due to a sudden influx of torque by storing in advance and determining driving situations in which torque steer occurs in certain driving conditions, so that the instability of vehicle behaviors in the event of the torque steer is resolved in advance without a separate compensation logic, thereby enabling more stable and smooth driving.

According to the present disclosure, a gear shift control system for a vehicle includes a controller including a driving information unit configured to detect driving information regarding a driving state of the vehicle; a driving situation determination unit provided with a torque steer monitoring mode for performing torque steer monitoring and configured to detect torque steer based on the driving information of the driving information unit; an up-counter operation unit configured to count a number of occurrences of the torque steer in the torque steer monitoring mode of the driving situation determination unit; a torque-steer and driving-information storage unit configured to store the number of occurrences of the torque steer provided by the up-counter operation unit and a driving situation provided by the driving information unit when the torque steer occurs; and the controller configured to counteract the torque steer based on the driving situation provided by the driving information unit.

Further, the system may include a torque-steer prediction and blocking unit provided with a pre-torque steer prevention mode and configured to predict and prevent the torque steer based on the number of occurrences of the torque steer and the driving situation when the torque steer occurs.

In addition, the driving situation determination unit collects and analyzes one or more kinds of the driving information during high-speed driving and curve driving of the vehicle, so as to determine whether the state requires the torque steer monitoring, thereby determining whether to enter the torque steer monitoring mode.

According to one aspect of the present disclosure, there is provided a gear shift control system for torque steer prevention based on predicting rapid acceleration situations, the system including: a driving information unit configured to detect driving information regarding a driving state of a vehicle; a driving situation determination unit provided with a torque steer monitoring mode for performing torque steer monitoring and configured to detect torque steer based on the driving information of the driving information unit; an up-counter operation unit configured to count the number of occurrences of the torque steer in the torque steer monitoring mode of the driving situation determination unit; a torque-steer and driving-information storage unit configured to store the number of occurrences of the torque steer provided by the up-counter operation unit and a driving situation provided by the driving information unit when the torque steer occurs; and a torque-steer prediction and blocking unit provided with a pre-torque steer prevention mode and configured to predict and prevent the torque steer based on the number of occurrences of the torque steer and the driving situation when the torque steer occurs, wherein the driving situation determination unit collects and analyzes one or more kinds of the driving information during high-speed driving and curve driving of the vehicle, so as to determine whether the state requires the torque steer monitoring, thereby determining whether to enter the torque steer monitoring mode.

In addition, the driving information unit may provide first to fourth driving information to the driving situation determination unit, and the driving situation determination unit may perform the torque steer monitoring mode when conditions are met, the conditions being either one of first and second driving conditions respectively preset for the first driving information regarding driver rapid acceleration and the second driving information regarding the curve driving, and both third and fourth driving conditions respectively preset for the third driving information regarding vehicle speed output and the fourth driving information regarding an accelerator pedal.

Preferably, the first driving information may be rapid acceleration possibility information based on a distance from a vehicle ahead and presence or absence of a speed camera ahead, the second driving information may be curve driving information including a curvature of a road ahead and lateral acceleration, The third driving information is vehicle speed output information including a vehicle speed, a current gear number, and turbine torque, and the fourth driving information may be accelerator pedal information including a position of the accelerator pedal and a gradient of the accelerator pedal.

In addition, the driving situation determination unit may determine an occurrence of torque steer when a condition is met, the condition being either a first condition in which an absolute value of a difference between a steering angle and a vehicle yaw angle, which are provided by the driving information unit, is greater than or equal to a first constant value preset for each vehicle speed, or a second condition in which a wheel speed difference between wheels on both sides is greater than or equal to a second constant value preset for each vehicle speed in a steady driving state where each of the steering angle and the vehicle yaw angle is 0, and the up-counter operation unit may count the number of occurrences of the torque steer.

In addition, when the torque steer occurs, the torque-steer and driving-information storage unit may store: an amount of torque steer according to the difference between the steering angle and the vehicle yaw angle; and driving situation information obtained when the torque steer occurs including a vehicle speed, an engine RPM (rotations per minute), turbine torque, an accelerator pedal amount, and a current gear number.

In addition, the driving situation determination unit may determine whether a count condition in which the number of occurrences of the torque steer of the up-counter operation unit is greater than or equal to a predetermined count is met, and thereafter, when the count condition is met, the torque-steer prediction and blocking unit may determine whether current driving situation information falls within a predetermined range of the driving situation information obtained when

the torque steer occurs, so as to determine whether the situation is one involving torque steer predicted to occur and then determine whether there is a downshifting request, and may make a determination by comparing the amount of torque steer with a torque limit amount, both of which are stored in the torque-steer and driving-information storage unit, when the downshifting request exists, thereby performing gear shifting inhibition and a function of Engine Torque Limit (ETL) or Engine Torque Request (ETR) when the amount of torque steer exceeds the torque limit amount or making a request for new gear shifting to a higher gear than an existing requested gear when the amount of torque steer does not exceed the torque limit amount.

According to the present disclosure, a control method of a gear shift control system for torque steer prevention based on predicting rapid acceleration situations includes steps of: (a) detecting, by a driving information unit of a controller, driving information regarding a driving state of a vehicle; (b) performing, by a driving situation determination unit of the controller provided with a torque steer monitoring mode, torque steer monitoring by detecting whether the driving state requires torque steer monitoring based on the driving information of the driving information unit; (c) determining, by the driving situation determination unit, whether a count condition in which the number of occurrences of torque steer is greater than or equal to a predetermined count is met; (d) detecting an occurrence of torque steer by the driving situation determination unit, and counting the number of occurrences of the torque steer by an up-counter operation unit; (e) storing, by a torque-steer and driving-information storage unit, the number of occurrences of the torque steer provided by the up-counter operation unit and a driving situation when the torque steer occurs provided by the driving information unit; and (f) counteracting, by the controller, the torque steer based on the driving situation provided by the driving information unit.

According to another aspect of the present disclosure for solving the above-described problem, there is provided a control method of a gear shift control system for torque steer prevention based on predicting rapid acceleration situations, the control method including: (a) detecting, by a driving information unit, driving information regarding a driving state of a vehicle; (b) performing, by a driving situation determination unit provided with a torque steer monitoring mode, torque steer monitoring by detecting whether the state requires the torque steer monitoring based on the driving information of the driving information unit; (c) determining, by the driving situation determination unit, whether a count condition in which the number of occurrences of torque steer is greater than or equal to a predetermined count is met; (d) detecting an occurrence of torque steer by the driving situation determination unit, and counting the number of occurrences of the torque steer by an up-counter operation unit; (e) storing, by a torque-steer and driving-information storage unit, the number of occurrences of the torque steer provided by the up-counter operation unit and a driving situation when the torque steer occurs provided by the driving information unit; and (f) predicting and preventing, by a torque-steer prediction and blocking unit provided with a pre-torque steer prevention mode, the torque steer based on the driving situation provided by the driving information unit.

In step (a), the driving information unit may provide, to the driving situation determination unit, first to fourth driving information of which the first driving information is rapid acceleration possibility information based on a distance from a vehicle ahead and presence or absence of a speed camera ahead, the second driving information is curve driving information including a curvature of a road ahead and lateral acceleration, the third driving information is vehicle output information including a vehicle speed, a current gear number, turbine torque, and the fourth driving information is accelerator pedal information including a position of an accelerator pedal and a gradient of the accelerator pedal, and in step (b), the driving situation determination unit may collect and analyze the first to fourth driving information, so as to determine whether the state requires the torque steer monitoring, thereby determining whether to enter the torque steer monitoring mode.

In step (b), the driving situation determination unit may perform the torque steer monitoring mode when conditions are met, the conditions being either one of first and second driving conditions respectively preset for the first driving information regarding driver rapid acceleration and the second driving information regarding curve driving, and both third and fourth driving conditions respectively preset for the third driving information regarding vehicle speed output and the fourth driving information regarding the accelerator pedal, and receive the driving information again from the driving information unit when neither of the first and second driving conditions is met, or when the third and fourth driving conditions are not met while either one of the first and second driving conditions is met.

In step (d), the driving situation determination unit may determine the occurrence of torque steer when a condition is met, the condition being either a first condition in which an absolute value of a difference between a steering angle and a vehicle yaw angle is greater than or equal to a first constant value preset for each vehicle speed, or a second condition in which a wheel speed difference between wheels on both sides is greater than or equal to a second constant value according to setting for each vehicle speed in a steady driving state where each of the steering angle and the vehicle yaw angle is 0, and the up-counter operation unit may count the number of occurrences of the torque steer, and receive the driving information again provided from the driving information unit when neither of the first condition nor the second condition is met.

In step (d), the torque-steer and driving-information storage unit may store: an amount of torque steer according to the difference between the steering angle and the vehicle yaw angle when the torque steer occurs; and driving situation information obtained when the torque steer occurs including the vehicle speed, an engine RPM (rotations per minute), the turbine torque, an accelerator pedal amount, and the current gear number.

In addition, when the driving situation determination unit determines in step (c) that the count condition in which the number of occurrences of the torque steer of the up-counter operation unit is greater than or equal to the predetermined count is met, step (f) may include: entering, by the torque steer prediction blocking unit, the pre-torque steer prevention mode; determining, by the torque-steer prediction and blocking unit, a torque steer predicted situation to determine whether the situation is one involving torque steer predicted; returning to step (a) when the situation is not the one involving the torque steer predicted in the determining of the torque steer predicted situation; determining whether there is a downshifting request for the rapid acceleration when the situation is determined as the torque steer predicted situation in the determining of the torque steer predicted situation; making a determination, by the torque-steer prediction and blocking unit, by comparing an amount of torque steer with a torque limit amount, both of which are stored in the torque-steer and driving-information storage unit, when there is the downshifting request in the torque-steer and driving-information storage unit; and performing, by the torque-steer prediction and blocking unit, gear shifting inhibition and a function of Engine Torque Limit (ETL) or Engine Torque Request (ETR) when the amount of torque steer exceeds the torque limit amount.

In addition, the determining of the torque steer predicted situation in step (f) causes a process to be performed by the torque-steer prediction and blocking unit, the process determining whether the current driving situation information falls within the predetermined range of the driving situation information obtained when the torque steer occurs, so as to determine whether the situation is the one involving the torque steer predicted to occur.

In addition, step (f) may further include making a request for new gear shifting, by the torque-steer prediction and blocking unit, to a higher gear than an existing requested gear when the amount of torque steer does not exceed the torque limit amount.

According to the present disclosure, a non-transitory computer readable medium containing program instructions executed by a processor includes: program instructions that detect driving information regarding a driving state of a vehicle; program instructions that perform torque steer monitoring by detecting whether the driving state requires torque steer monitoring based on the driving information; program instructions that determine whether a count condition in which the number of occurrences of torque steer is greater than or equal to a predetermined count is met; program instructions that detect an occurrence of torque steer and count the number of occurrences of the torque steer; program instructions that store the number of occurrences of the torque steer and a driving situation when the torque steer occurs; and program instructions that predict and prevent the torque steer based on the driving situation.

According to one exemplary embodiment of the present disclosure, the embodiment of the present disclosure has a realized effect of preventing torque steer due to a sudden influx of torque by storing in advance driving situations in which torque steer occurs in certain driving conditions.

In addition, according to one exemplary embodiment of the present disclosure, the present disclosure has another realized effect of preemptively storing driving situations in which torque steer occurs, predicting a situation involving torque steer to occur, and proactively responding to such a phenomenon without using a separate compensation logic, so that the instability of vehicle behaviors in the event of the torque steer is resolved in advance without the separate compensation logic, thereby enabling more stable and smooth driving.

### BRIEF DESCRIPTION OF THE DRAWINGS

FIG. 1 is a schematic view of a gear shift control system for torque steer prevention based on predicting rapid acceleration situations according to one exemplary embodiment of the present disclosure.

FIG. 2 is a flowchart of a control method of a gear shift control system for torque steer prevention based on predicting rapid acceleration situations according to one exemplary embodiment of the present disclosure.

### DETAILED DESCRIPTION OF THE DISCLOSURE

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms "a," "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, preferred exemplary embodiments of the present disclosure will be described in detail with reference to the drawings.

The embodiment of present disclosure is a technology for predicting in advance an event where torque steer occurs, and predicting an event where a problem may occur during driving affecting the transmission, thereby preventing the torque steer due to an excessive influx of torque.

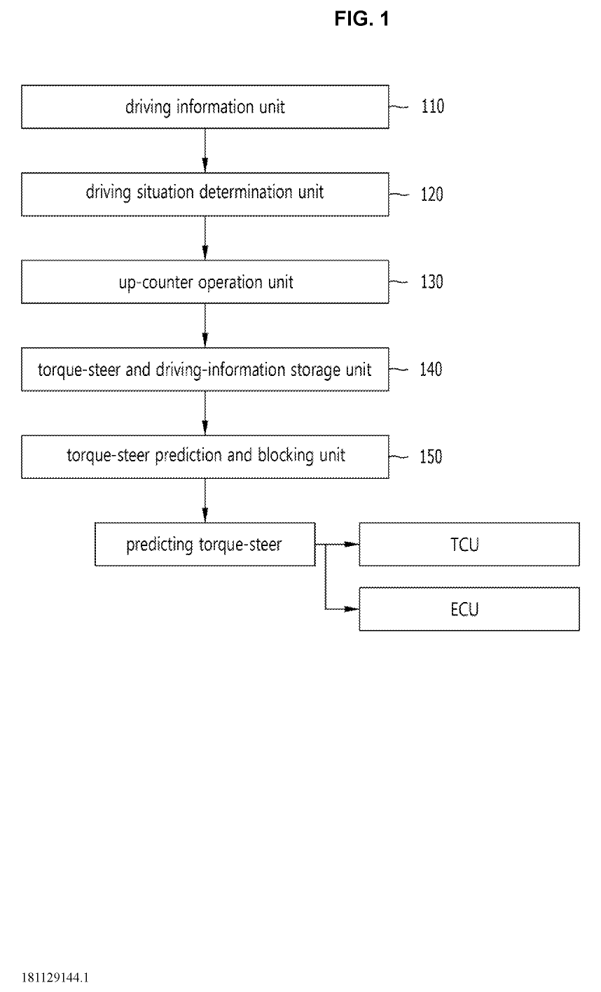

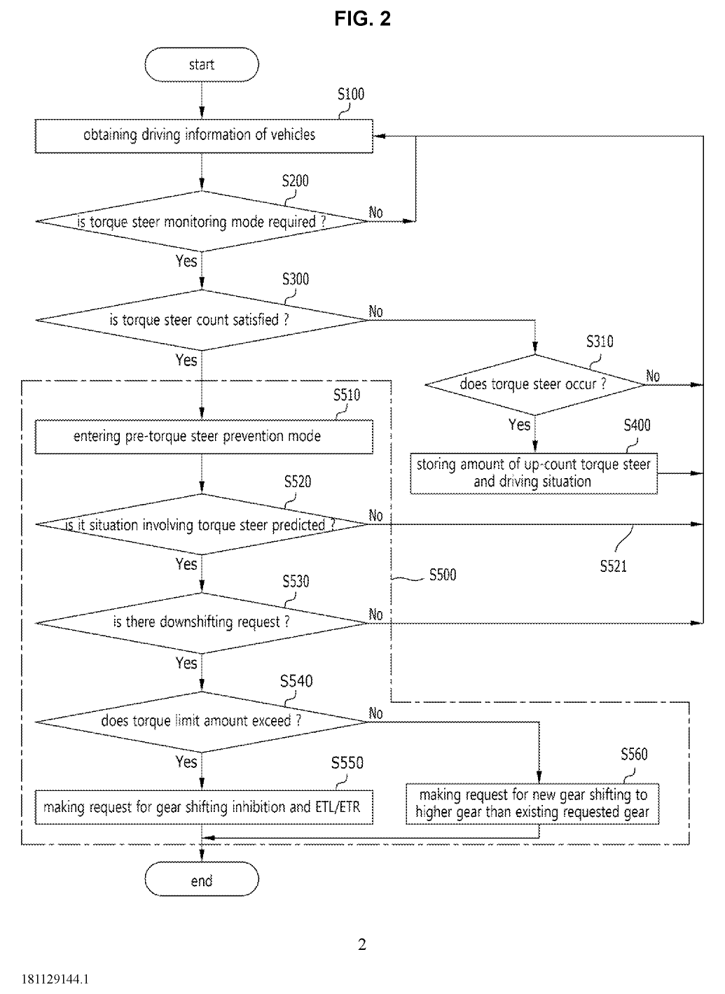

FIG. 1 is a schematic view of a gear shift control system for torque steer prevention based on predicting rapid acceleration situations according to one exemplary embodiment of the present disclosure. FIG. 2 is a flowchart of a control method of a gear shift control system for torque steer prevention based on predicting rapid acceleration situations according to one exemplary embodiment of the present disclosure.

Referring to FIGS. 1 and 2, according to one exemplary embodiment of the present disclosure, there is provided the gear shift control system 100 for torque steer prevention based on predicting rapid acceleration situations, the system including: a driving information unit 110 configured to detect driving information regarding a driving state of a vehicle; a driving situation determination unit 120 provided with a torque steer monitoring mode for performing torque steer monitoring and configured to detect torque steer based on the driving information of the driving information unit 110; an up-counter operation unit 130 configured to count the number of occurrences of the torque steer in the torque steer monitoring mode of the driving situation determination unit; a torque-steer and driving-information storage unit 140 configured to store the number of occurrences of the torque steer provided by the up-counter operation unit 130 and a driving situation provided by the driving information unit 110 when the torque steer occurs; and a torque-steer prediction and blocking unit 150 provided with a pre-torque steer prevention mode and configured to predict and prevent the torque steer based on the number of occurrences of the torque steer and the driving situation when the torque steer occurs.

Each of the above units may constitute modules and/or devices of the gear shift control system 100, which may constitute a controller. For example, the above units of the gear shift control system 100 may constitute hardware components that form part of a controller (e.g., modules or devices of a high-level controller), or may constitute individual controllers each having a processor and memory. The gear shift control system 100 may include one or more processors and memory.

Here, the driving information unit 110 is a component for detecting not only information on general behaviors of a driving vehicle but also control information for maintaining the behaviors. The driving information unit 110 may detect changes in the opening of a throttle valve interworking with the operation of an accelerator pedal, detect changes in the vane angle of a turbocharger, detect a yaw moment that tends to move toward an inner or outer wheel relative to the center point of the vehicle while in motion, detect the vehicle speed of the driving vehicle, detect the steering angle displacement of a steering wheel that controls drive wheels, and detect steering torque generated by a driver.

Such a driving information unit 110 may provide first to fourth driving information to the driving situation determination unit 120. Preferably, the first driving information is rapid acceleration possibility information based on a distance from a vehicle ahead and presence or absence of a speed camera ahead, the second driving information is curve driving information including a curvature of a road ahead and lateral acceleration, the third driving information is vehicle speed output information including a vehicle speed, a current gear number, and turbine torque, and the fourth driving information is accelerator pedal information including a position of the accelerator pedal and a gradient of the accelerator pedal.

In addition, the driving situation determination unit 120 collects and analyzes one or more kinds of the driving information during high-speed driving and curve driving of the vehicle, so as to determine whether the state requires the torque steer monitoring, thereby determining whether to enter the torque steer monitoring mode.

More specifically, the driving situation determination unit 120 may perform the torque steer monitoring mode when conditions are met, the conditions being either one of first and second driving conditions respectively preset for the first driving information regarding driver rapid acceleration and the second driving information regarding curve driving, and both third and fourth driving conditions respectively preset for the third driving information regarding vehicle speed output and the fourth driving information regarding an accelerator pedal.

Here, the first driving condition is a condition that is met when a distance from a vehicle ahead is greater than or equal to a predetermined value preset for each vehicle speed and there is no front speed camera, and the second driving condition is a condition that is met when a curvature of a road ahead is greater than or equal to a predetermined value preset for each vehicle speed and lateral acceleration is greater than or equal to a predetermined value.

In this case, the first driving condition represents a situation of possible rapid acceleration by a driver, and the second driving condition represents a situation of making the probability of occurring the torque steer to increase in assumption of a curve driving situation.

In addition, the third driving condition is a condition that is met when a vehicle speed is a predetermined value, the current gear number is a certain number or higher, and turbine torque has a predetermined value or higher preset for each vehicle speed. In this case, the turbine torque has the value measured at a turbocharger.

In addition, the fourth driving condition is a condition that is met when a displacement value of an accelerator pedal is a predetermined value and a gradient of operating speed of the accelerator pedal has a predetermined value or higher.

The driving situation determination unit 120 enters the torque steer monitoring mode when both the third driving condition and the fourth driving condition are met while either one of the first driving condition and the second driving condition is met. When the driving situation determination unit 120 enters the torque steer monitoring, a torque steer prevention mode may also be initiated by the torque steer prediction blocking unit 150.

The up-counter operation unit 130 monitors whether torque steer actually occurs during driving and counts the number of occurrences of the torque steer. At this time, the monitoring count of the up-counter operation unit 130 is reset when a driving cycle elapses.

That is, the up-counter operation unit 130 may count the number of occurrences of the torque steer based on determining an occurrence of torque steer when a condition is met, the condition being either a first condition in which an absolute value of a difference between a steering angle and a vehicle yaw angle, which are provided by the driving information unit 110, is greater than or equal to a first constant value preset for each vehicle speed, or a second condition in which a wheel speed difference between wheels on both sides is greater than or equal to a second constant value preset for each vehicle speed in a steady driving state where each of the steering angle and the vehicle yaw angle is 0. Here, the first and second constant values are specified as values for each vehicle speed during a driving test in vehicle development and stored in the format of mapping data, and may be values that are read out according to the vehicle speed.

In this way, the up-counter operation unit 130 counts the number of occurrences of the torque steer when either the first condition or the second condition is met. In this way, the number of occurrences of torque steer counted by the up-counter operation unit 130 is recorded in the torque-steer and driving-information storage unit 140.

When the torque steer occurs, the torque-steer and driving-information storage unit 140 may store: an amount of torque steer according to a difference between a steering angle and a vehicle yaw angle; and driving situation information including vehicle speeds, an engine RPM (rotations per minute), turbine torque, an accelerator pedal amount, and a current gear number.

In the present exemplary embodiment, when the number of torque steering occurrences based on the monitoring count of the up-counter operation unit 130 during a driving cycle is less than a predetermined count, the count is reset and the current process returns to the starting point of receiving driving information from the driving information unit 110.

Meanwhile, the driving situation determination unit 120 determines whether a count condition in which the number of occurrences of the torque steer of the up-counter operation unit 130 is greater than or equal to a predetermined count is met. Next, when the count condition is met, the torque-steer prediction and blocking unit determines whether the current driving situation information falls within a predetermined range of driving situation information obtained when the torque steer occurs so as to determine whether the situation is one involving torque steer predicted to occur and then determines whether a downshifting request is made. When there is the downshifting request, the torque-steer prediction and blocking unit makes a determination by comparing an torque steer generation amount with a torque limit amount, both of which are stored in the torque-steer and driving-information storage unit 140. Here, the torque limit occurrence amount is a value calculable through vehicle design and vehicle driving tests, and may be a value of the maximum torque limit that a transmission and drive shafts can withstand at a specific gear of a transmission under driving conditions.

Thereafter, the torque steer prediction blocking unit 150 may make a request for new gear shifting to a higher gear than the existing requested gear when the amount of torque steer does not exceed the torque limit amount.

Conversely, when the amount of torque steer generated exceeds the torque limit generated, the torque steer prediction blocking unit 150 may make a request for gear shifting inhibition and perform a function of Engine Torque Limit (ETL) or Engine Torque Request (ETR), and may make a request Engine Torque Limit (ETL) and Engine Torque Request (ETR) simultaneously.

The torque steer prediction blocking unit 150 may make requests for gear shifting inhibition and new gear shifting to a high gear to a transmission control unit (TCU), and may make a request for the Engine Torque Limit (ETL) and Engine Torque Request (ETR) to an engine control unit (ECU) so as to limit an engine RPM.

Meanwhile, the torque steer prediction blocking unit 150 may determine a control value of basic steering-assist torque according to a steering angle and steering torque, and superimposes a steering torque value, which is for torque steer reduction and offset and transmitted from a vehicle body control unit to a network, on the control value of the basic steering-assist torque, and may be connected to a steering control unit that controls the operation of a steering motor, so as to provide information on torque steer driving situations to the steering control unit. Accordingly, the steering control unit may appropriately control the steering motor to eliminate the torque steer when a torque steer blocking signal is generated in which an amount of torque steer exceeds a torque limit amount in the torque steer blocking mode.

Hereinafter, a control method of a gear shift control system for torque steer prevention based on predicting rapid acceleration situations according to another exemplary embodiment of the present disclosure is described.

Referring to FIGS. 1 and 2, according to another exemplary embodiment of the present disclosure, there is provided a control method of a gear shift control system 100 for torque steer prevention based on predicting rapid acceleration situations, the method including: (a) step S100 of detecting, by a driving information unit 110, driving information regarding a driving state of a vehicle; (b) step S200 of performing, by a driving situation determination unit 120 provided with a torque steer monitoring mode, torque steer monitoring by detecting whether the driving state requires the torque steer monitoring based on the driving information of the driving information unit 110; (c) step S300 of determining, by the driving situation determination unit 120, whether a count condition in which the number of occurrences of the torque steer is greater than or equal to a predetermined count is met; (d) step S310 of detecting an occurrence of torque steer by the driving situation determination unit 120, and counting the number of occurrences of the torque steer by an up-counter operation unit 130; (e) step S400 of storing, by a torque-steer and driving-information storage unit 140, the number of occurrences of the torque steer provided by the up-counter operation unit 130

and a driving situation when torque steer occurs provided by the driving information unit 110; and (f) step S500 of predicting and preventing, by a torque-steer prediction and blocking unit 150 provided with a pre-torque steer prevention mode, torque steer based on the driving situation provided by the driving information unit 110.

In (a) step S100, the driving information unit 110 provides first to fourth driving information to the driving situation determination unit 120. In this case, the first driving information is rapid acceleration possibility information based on a distance from a vehicle ahead as well as the presence or absence of a front speed camera, the second driving information is curve driving information including a curvature of a road ahead and lateral acceleration, the third driving information is vehicle speed output information including vehicle speeds, a current gear number, and turbine torque, and the fourth driving information is accelerator pedal information including a position of an accelerator pedal and a gradient of the accelerator pedal.

In (b) step S200, the driving situation determination unit 120 may collect and analyze the first to fourth driving information, so as to determine whether the state requires the torque steer monitoring, thereby determining whether to enter the torque steer monitoring mode.

In addition, in step (b) S200, the driving situation determination unit 120 may perform the torque steer monitoring mode when conditions are met, the conditions being either one of first and second driving conditions respectively preset for the first driving information regarding driver rapid acceleration and the second driving information regarding curve driving, and both third and fourth driving conditions respectively preset for the third driving information regarding vehicle speed output and the fourth driving information regarding an accelerator pedal, and the driving situation determination unit 120 may receive the driving information again from the driving information unit 110 when neither of the first and second driving conditions is met, or when the third and fourth driving conditions are not met while either of the first and second driving conditions is met.

In addition, in (d) step S310, the driving situation determination unit 120 may determine an occurrence of torque steer when a condition is met, the condition being either a first condition in which an absolute value of a difference between a steering angle and a vehicle yaw angle is greater than or equal to a first constant value preset for each vehicle speed, or a second condition in which a wheel speed difference between wheels on both sides is greater than or equal to a second constant value preset for each vehicle speed in a steady driving state where each of the steering angle and the vehicle yaw angle is 0, and the up-counter operation unit 130 counts the number of occurrences of the torque steer.

As such, in (d) step S310, when neither of the first condition and the second condition is met, the current process may return to the point where driving information is provided again from the driving information unit 110.

Next, when the torque steer is determined to occur, the torque-steer and driving-information storage unit 140 may perform step S400 of storing an amount of torque steer according to a difference between a steering angle and a vehicle yaw angle, and driving situation information including vehicle speeds, an engine RPM, turbine torque, an accelerator pedal amount, and a current gear number.

In addition, as for (f) step S500, this step is performed when the driving situation determination unit determines in step (c) that the count condition in which the number of occurrences of the torque steer of the up-counter operation unit is greater than or equal to a predetermined count is met.

Step (f) S500 may include: step S510 of entering, by the torque steer prediction blocking unit, the pre-torque steer prevention mode; step S520 of determining, by the torque steer prediction blocking unit 150, a torque steer predicted situation to determine whether the situation is one involving torque steer predicted to occur; step S521 of returning to step (a) when the situation is not the one involving torque steer predicted to occur in the determining of the torque steer predicted situation; and step S530 of determining whether there is a downshifting request for the rapid acceleration when the situation is determined as the torque steer predicted situation in the determining of the torque steer predicted situation in step S520.

In addition, in step S530 of determining whether there is the downshifting request, the current process returns to step (a) when there is no downshifting request for the rapid acceleration.

In addition, step (f) S500 may include: step S540 of making, by the torque steer prediction blocking unit 150, a determination by comparing the amount of torque steer with the torque limit amount, both of which are stored in the torque-steer and driving-information storage unit 140, when there is the downshifting request; and step S550 of performing, by the torque steer prediction blocking unit 150, gear shifting inhibition and a function of Engine Torque Limit (ETL) or Engine Torque Request (ETR) when the amount of torque steer exceeds the torque limit amount.

In addition, step S520 of determining the torque steer predicted situation in step (f) may cause a process to be performed by the torque-steer prediction and blocking unit, the process determining whether the current driving situation information falls within a predetermined range of driving situation information obtained when the torque steer occurs so as to determine whether the situation is one involving the torque steer predicted to occur. Here, the predetermined range can be set to, for example, 0.95 to 1.05 times these values of the driving situation information in order to determine whether the current driving situation information is close to values of the pieces of the driving situation information stored when the torque steer occurs, such as vehicle speeds, an engine RPM, turbine torque, and a value of an accelerator pedal. However, since a range is unable to be given for gear numbers, the stored gear number and the gear number for the current driving situation are compared as it is, thereby making a determination.

In addition, step (f) S500 may further include step S560 of making a request for new gear shifting to a higher gear than the existing requested gear when the amount of torque steer does not exceed the torque limit amount.

As described above, according to the exemplary embodiments of the present disclosure, it is possible to prevent the occurrence of torque steer due to a sudden influx of torque by storing in advance driving situations in which the torque steer occurs in certain driving conditions.

In addition, according to the exemplary embodiments of the present disclosure, it is possible to store in advance the driving situations in which torque steer occurs, predict a situation involving torque steer to occur, and preemptively respond to such a torque steer phenomenon without using a separate compensation logic, so that the instability of vehicle behaviors when the torque steer occurs is resolved without the separate compensation logic, thereby enabling more stable and smooth driving.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A gear shift control system for a vehicle, the system comprising:
a controller comprising:
a driving information unit configured to detect driving information regarding a driving state of the vehicle;
a driving situation determination unit provided with a torque steer monitoring mode for performing torque steer monitoring and configured to detect torque steer based on the driving information of the driving information unit;
an up-counter operation unit configured to count a number of occurrences of the torque steer in the torque steer monitoring mode of the driving situation determination unit;
a torque-steer and driving-information storage unit configured to store the number of occurrences of the torque steer provided by the up-counter operation unit and a driving situation provided by the driving information unit when the torque steer occurs; and
the controller configured to counteract the torque steer based on the driving situation provided by the driving information unit.

2. The system of claim 1, further comprising: a torque-steer prediction and blocking unit provided with a pre-torque steer prevention mode and configured to predict and prevent the torque steer based on the number of occurrences of the torque steer and the driving situation when the torque steer occurs.

3. The system of claim 1,
wherein the driving situation determination unit collects and analyzes one or more kinds of the driving information during high-speed driving and curve driving of the vehicle, so as to determine whether the state requires the torque steer monitoring, thereby determining whether to enter the torque steer monitoring mode.

4. The system of claim 1, wherein the driving information unit provides first to fourth driving information to the driving situation determination unit, and
the driving situation determination unit performs the torque steer monitoring mode when conditions are met, the conditions being either one of first and second driving conditions respectively preset for the first driving information regarding driver rapid acceleration and the second driving information regarding the curve driving, and both third and fourth driving conditions respectively preset for the third driving information regarding vehicle speed output and the fourth driving information regarding an accelerator pedal.

5. The system of claim 4, wherein the first driving information is rapid acceleration possibility information based on a distance from a vehicle ahead and presence or absence of a speed camera ahead,
the second driving information is curve driving information comprising a curvature of a road ahead and lateral acceleration,
the third driving information is vehicle speed output information comprising a vehicle speed, a current gear number, and turbine torque, and
the fourth driving information is accelerator pedal information comprising a position of the accelerator pedal and a gradient of the accelerator pedal.

6. The system of claim 4, wherein the driving situation determination unit determines an occurrence of torque steer when a condition is met, the condition being either a first condition in which an absolute value of a difference between a steering angle and a vehicle yaw angle, which are provided by the driving information unit, is greater than or equal to a first constant value preset for each vehicle speed, or a second condition in which a wheel speed difference between wheels on both sides is greater than or equal to a second constant value preset for each vehicle speed in a steady driving state where each of the steering angle and the vehicle yaw angle is 0, and
the up-counter operation unit counts the number of occurrences of the torque steer.

7. The system of claim 6, wherein when the torque steer occurs, the torque-steer and driving-information storage unit stores:
an amount of torque steer according to the difference between the steering angle and the vehicle yaw angle; and
driving situation information obtained when the torque steer occurs comprising a vehicle speed, an engine RPM (rotations per minute), turbine torque, an accelerator pedal amount, and a current gear number.

8. The system of claim 7, wherein the driving situation determination unit determines whether a count condition in which the number of occurrences of the torque steer of the up-counter operation unit is greater than or equal to a predetermined count is met, and
thereafter, when the count condition is met, the torque-steer prediction and blocking unit determines whether current driving situation information falls within a predetermined range of the driving situation information obtained when the torque steer occurs, so as to determine whether the situation is one involving torque steer predicted to occur and then determine whether there is a downshifting request, and makes a determination by comparing the amount of torque steer with a torque limit amount, both of which are stored in the torque-steer and driving-information storage unit, when the downshifting request exists, thereby performing gear shifting inhibition and a function of Engine Torque Limit (ETL) or Engine Torque Request (ETR) when the amount of torque steer exceeds the torque limit amount or making a request for new gear shifting to a higher gear than an existing requested gear when the amount of torque steer does not exceed the torque limit amount.

9. A vehicle comprising the gear shift control system of claim 1.

10. A control method of a gear shift control system for torque steer prevention based on predicting rapid acceleration situations, the control method comprising:
(a) detecting, by a driving information unit of a controller, driving information regarding a driving state of a vehicle;
(b) performing, by a driving situation determination unit of the controller provided with a torque steer monitoring mode, torque steer monitoring by detecting whether the driving state requires torque steer monitoring based on the driving information of the driving information unit;
(c) determining, by the driving situation determination unit, whether a count condition in which the number of occurrences of torque steer is greater than or equal to a predetermined count is met;
(d) detecting an occurrence of torque steer by the driving situation determination unit, and counting the number of occurrences of the torque steer by an up-counter operation unit;
(e) storing, by a torque-steer and driving-information storage unit, the number of occurrences of the torque steer provided by the up-counter operation unit and a driving situation when the torque steer occurs provided by the driving information unit; and
(f) counteracting, by the controller, the torque steer based on the driving situation provided by the driving information unit.

11. The method of claim 10, wherein the controller is configured to predict and prevent the torque steer based on the driving situation provided by the driving information unit.

12. The method of claim 11, wherein the controller further comprises a torque steer prediction and blocking unit for predicting and preventing the torque steer.

13. The control method of claim 10, wherein in step (a), the driving information unit provides, to the driving situation determination unit, first to fourth driving information of which the first driving information is rapid acceleration possibility information based on a distance from a vehicle ahead and presence or absence of a speed camera ahead, the second driving information is curve driving information comprising a curvature of a road ahead and lateral acceleration, the third driving information is vehicle output information comprising a vehicle speed, a current gear number, turbine torque, and the fourth driving information is accelerator pedal information comprising a position of an accelerator pedal and a gradient of the accelerator pedal, and
in step (b), the driving situation determination unit collects and analyzes the first to fourth driving information, so as to determine whether the state requires the torque steer monitoring, thereby determining whether to enter the torque steer monitoring mode.

14. The control method of claim 13, wherein in step (b), the driving situation determination unit performs the torque steer monitoring mode when conditions are met, the conditions being either one of first and second driving conditions respectively preset for the first driving information regarding driver rapid acceleration and the second driving information regarding curve driving, and both third and fourth driving conditions respectively preset for the third driving information regarding vehicle speed output and the fourth driving information regarding the accelerator pedal, and receives the driving information again from the driving information unit when neither of the first and second driving conditions is met, or when the third and fourth driving conditions are not met while either one of the first and second driving conditions is met.

15. The control method of claim 14, wherein in step (d), the driving situation determination unit determines the occurrence of torque steer when a condition is met, the condition being either a first condition in which an absolute value of a difference between a steering angle and a vehicle yaw angle is greater than or equal to a first constant value preset for each vehicle speed, or a second condition in which a wheel speed difference between wheels on both sides is greater than or equal to a second constant value according to setting for each vehicle speed in a steady driving state where each of the steering angle and the vehicle yaw angle is 0, and
the up-counter operation unit counts the number of occurrences of the torque steer, and receives the driving information again provided from the driving information unit when neither of the first condition nor the second condition is met.

16. The control method of claim 15, wherein in step (d), the torque-steer and driving-information storage unit stores:
an amount of torque steer according to the difference between the steering angle and the vehicle yaw angle when the torque steer occurs; and
driving situation information obtained when the torque steer occurs comprising the vehicle speed, an engine RPM (rotations per minute), the turbine torque, an accelerator pedal amount, and the current gear number.

17. The control method of claim 15, wherein when the driving situation determination unit determines in step (c) that the count condition in which the number of occurrences of the torque steer of the up-counter operation unit is greater than or equal to the predetermined count is met, step (f) comprises:
entering, by the torque steer prediction blocking unit, the pre-torque steer prevention mode;
determining, by the torque-steer prediction and blocking unit, a torque steer predicted situation to determine whether the situation is one involving torque steer predicted;
returning to step (a) when the situation is not the one involving the torque steer predicted in the determining of the torque steer predicted situation;
determining whether there is a downshifting request for the rapid acceleration when the situation is determined as the torque steer predicted situation in the determining of the torque steer predicted situation;
making a determination, by the torque-steer prediction and blocking unit, by comparing an amount of torque steer with a torque limit amount, both of which are stored in the torque-steer and driving-information storage unit, when there is the downshifting request in the torque-steer and driving-information storage unit; and
performing, by the torque-steer prediction and blocking unit, gear shifting inhibition and a function of Engine Torque Limit (ETL) or Engine Torque Request (ETR) when the amount of torque steer exceeds the torque limit amount.

18. The control method of claim 17, wherein the determining of the torque steer predicted situation in step (f) causes a process to be performed by the torque-steer prediction and blocking unit, the process determining whether the current driving situation information falls within the predetermined range of the driving situation information obtained when the torque steer occurs, so as to determine whether the situation is the one involving the torque steer predicted to occur.

19. The control method of claim 17, wherein step (f) further comprises:
making a request for new gear shifting, by the torque-steer prediction and blocking unit, to a higher gear than an existing requested gear when the amount of torque steer does not exceed the torque limit amount.

20. A non-transitory computer readable medium containing program instructions executed by a processor, the computer readable medium comprising:
program instructions that detect driving information regarding a driving state of a vehicle;
program instructions that perform torque steer monitoring by detecting whether the driving state requires torque steer monitoring based on the driving information;
program instructions that determine whether a count condition in which the number of occurrences of torque steer is greater than or equal to a predetermined count is met;
program instructions that detect an occurrence of torque steer and count the number of occurrences of the torque steer;
program instructions that store the number of occurrences of the torque steer and a driving situation when the torque steer occurs; and
program instructions that predict and prevent the torque steer based on the driving situation.
